(19) United States
(12) Patent Application Publication
(10) Pub. No.: US 2026/0307539 A1
(43) Pub. Date: Oct. 8, 2026

(54) ELECTRIC WORK VEHICLE

(71) Applicant: Kubota Corporation, Osaka (JP)

(72) Inventors: Shunya TAKASE, Sakai-shi (JP); Ryunosuke MATSUMOTO, Sakai-shi (JP); Tomohiro MISHIMA, Sakai-shi (JP); Masato SHIOZAKI, Sakai-shi (JP)

(21) Appl. No.: 19/681,450

(22) Filed: May 19, 2026

Related U.S. Application Data
(63) Continuation of application No. PCT/JP2024/043195, filed on Dec. 6, 2024.

(30) Foreign Application Priority Data
Dec. 27, 2023 (JP) 2023-221640

(51) Int. Cl. B60L 58/26; A01B 76/00; B60L 53/20; B60L 58/18; B60L 58/27

(52) U.S. Cl. CPC B60L 58/26; A01B 76/00; B60L 53/20; B60L 58/18; B60L 58/27; B60L 2200/40; B60L 2240/545

(57) ABSTRACT

An electric work vehicle includes a battery, an electric motor configured to transmit motive power to a travel device using power from the battery, a temperature regulator configured to regulate a temperature of the battery using power, and a temperature detector configured to detect the temperature of the battery. If the temperature detected by the temperature detector is lower than a first set temperature, the temperature regulator is configured to operate such that the temperature of the battery increases.

### CROSS REFERENCE TO RELATED APPLICATIONS

This application claims the benefit of priority to Japanese Patent Application No. 2023-221640 filed on Dec. 27, 2023 and is a Continuation Application of PCT Application No. PCT/JP 2024/043195 filed on Dec. 6, 2024. The entire contents of each application are hereby incorporated herein by reference.

### BACKGROUND OF THE INVENTION

### 1. Field of the Invention

The present invention relates to electric work vehicles each including a battery and an electric motor that transmits motive power to a travel device using power from the battery.

### 2. Description of the Related Art

Some of conventional electric tractors, which are an example of an electric work vehicle, include a cooling device that cools a battery, as disclosed in JP 2023-95636A, for example.

### SUMMARY OF THE INVENTION

For the above-described electric work vehicle, it is important to manage the temperature of the battery in order for the battery to be appropriately charged and discharged. The electric tractor disclosed in JP 2023-95636A includes the cooling device that cools the battery, and can take measures against elevated temperatures of the battery. However, when the electric tractor is operated while the temperature of the battery is low in a cold region or the like, the battery may not be able to be appropriately charged and discharged. For this reason, it is necessary to provide a configuration for not only cooling the battery, but also increasing the temperature of the battery in a case where the battery temperature is low. In particular, in a low-temperature environment where the battery temperature is below an allowable temperature range of the battery, the battery becomes inoperative, thus making it impossible to perform a charge operation for the battery, let alone drive a travel electric motor by the battery.

Example embodiments of the present invention provide electric work vehicles capable of regulating the temperature of a battery even in a low-temperature environment.

An electric work vehicle according to an example embodiment of the present invention includes a battery, an electric motor configured to transmit motive power to a travel device using power from the battery, a temperature regulator configured to regulate a temperature of the battery using power, and a temperature detector configured to detect a temperature of the battery, in response to the temperature detected by the temperature detector being lower than a first set temperature, the temperature regulator is configured to operate such that the temperature of the battery increases.

According to an example embodiment of the present invention, the temperature of the battery is increased by operating the temperature regulator if the temperature of the battery detected by the temperature detector is lower than the first set temperature. For example, a low temperature corresponding to the lower limit value of an allowable temperature range of the battery is set as the first set temperature. Although there is the possibility that the battery cannot operate at a temperature lower than the first set temperature, using the temperature regulator enables regulation of the temperature of the battery to bring the battery into an operative state.

Accordingly, it is possible to provide an electric work vehicle capable of regulating the temperature of the battery even in a low-temperature environment.

In an example embodiment of the present invention, it is preferable that the temperature regulator is configured to operate using power supplied from an external power source.

This configuration makes it possible to increase the temperature of the battery using the power supplied from the external power source even in a situation where the battery cannot operate in a low-temperature environment.

In an example embodiment of the present invention, it is preferable that, in response to the temperature of the battery detected by the temperature detector being higher than the first set temperature and lower than a second set temperature that is higher than the first set temperature, the temperature regulator is configured to operate using power supplied from the battery such that the temperature of the battery increases.

With this configuration, the battery becomes operative if the temperature of the battery is higher than the first set temperature. Accordingly, it is possible to operate the temperature regulator using power from the battery. As a result, it is possible to avoid the case where the temperature increasing operation of the temperature regulator that uses the external power source is performed for an unnecessarily long time, and unnecessary power consumption can be reduced or prevented by using the power stored in the battery.

In an example embodiment of the present invention, it is preferable that in response to the temperature of the battery increasing to the second set temperature or more, the temperature regulator is configured to stop a temperature increasing operation with respect to the battery.

This configuration makes it possible to reduce or prevent unnecessary consumption of not only the power from the external power source, but also power from the battery.

In an example embodiment of the present invention, it is preferable that the temperature regulator includes a circulation flow path through which a refrigerant circulates through an interior of the battery, and a heater configured to heat the refrigerant and perform a heating operation using received power.

With this configuration, the temperature of the battery can be increased by the heating medium that is heated by the heater and circulates through the circulation flow path. This configuration makes it possible to heat the battery with a higher thermal efficiency than a case where the battery is directly heated using heat from the heater.

In an example embodiment of the present invention, it is preferable that the electric work vehicle further includes a power converter configured to convert power supplied from an external power source into on-board power, and the temperature regulator is configured to switch a state of power supply in such a manner as to, in response to the temperature of the battery being lower than the first set temperature, convert the power supplied from the external power source into power suppliable to the heater as the on-board power and supply the converted power to the heater, and to, in response to the temperature of the battery being higher than the first set temperature, convert the power supplied from the external power source into power suppliable to the battery as the on-board power and supply the converted power to the battery.

With this configuration, the state of supply of the power received from the external power source can be switched between a state of supplying the power to the heater, and a state of supplying the power to the battery, and the operation of the temperature regulator at a low temperature and the charging of the battery in a normal operation can be performed satisfactorily.

In an example embodiment of the present invention, it is preferable that the battery is not charged while the temperature of the battery is lower than the first set temperature.

With this configuration, the battery is not charged in a low-temperature state lower than the first set temperature, and it is therefore possible to easily avoid problems such as early degradation of the battery.

In an example embodiment of the present invention, it is preferable that the battery is not discharged while the temperature of the battery is lower than the first set temperature.

With this configuration, the battery is not discharged in a low-temperature state lower than the first set temperature, and it is therefore possible to easily avoid problems such as early degradation of the battery.

In an example embodiment of the present invention, it is preferable that the battery includes a plurality of cells, the temperature detector is configured to detect a temperature for each of the plurality of cells, and the temperature regulator is configured to operate in response to a lowest temperature among the temperatures of the plurality of cells being lower than the first set temperature.

A battery including a plurality of cells exhibits variations in properties from one cell to another, and also exhibits variations in temperature changes. Therefore, with this configuration, whether the temperature regulator is to operate is determined based on the lowest temperature among the temperatures detected for the plurality of cells. For example, if the average value of a plurality of temperatures is used, some of the cells that have a temperature lower than the average value may be adversely affected and thus become inoperative. However, with this configuration, it is possible to satisfactorily perform temperature regulation without allowing such a problem to occur.

In an example embodiment of the present invention, it is preferable that motive power is transmittable to a work apparatus using power from the battery.

With this configuration, motive power is transmitted to a work apparatus using an electric motor, hydraulic equipment, or the like that operates using power from the battery, and various operations can be performed while the vehicle body is traveling.

In an example embodiment of the present invention, it is preferable that the electric work vehicle further includes a second battery different from the battery and configured to supply power to an electric component, and the second battery is configured to supply power to the electric component at a temperature lower than the first set temperature.

With this configuration, power is also supplied from the second battery to the electric component to operate the temperature regulator even if the temperature of the battery is the first set temperature or less. Accordingly, it is possible to satisfactorily operate the temperature regulator.

In an example embodiment of the present invention, it is preferable that the battery is a lithium ion battery, and the second battery is a lead-acid battery.

With this configuration, a lithium ion battery has a narrow operable temperature range, and is highly likely to become inoperative at a temperature less than or equal to the first set temperature. In contrast, a lead-acid battery has an operable temperature range that is wider than that of the lithium ion battery, and power can be supplied even at a temperature less than or equal to the first set temperature. Therefore, the second battery being a lead-acid battery makes it possible to supply power to the electric component to operate the temperature regulator even at a temperature less than or equal to the first set temperature.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an overall side view of an electric tractor.

FIG. 2 is an overall plan view of the electric tractor.

FIG. 3 is a block diagram showing a power system and a motive power system of the electric tractor.

FIG. 4 is a front view of a relevant portion showing a battery and devices disposed on the periphery of the battery.

FIG. 5 is a side view of a relevant portion showing the battery and a temperature regulation unit or the like.

FIG. 6 is a flowchart of a control operation.

### DETAILED DESCRIPTION OF THE EXAMPLE EMBODIMENTS

Electric work vehicles according to example embodiments of the present invention are applicable to electric tractors as examples of the electric work vehicles and will be described with reference to the drawings. In the following description, unless particularly specified otherwise, the arrow F shown in the drawings indicates the “forward direction”, the arrow B indicates the “rearward direction”, the arrow L indicates the “leftward direction”, and the arrow R indicates the “rightward direction”. In addition, the arrow U shown in the drawings indicates the “upward direction”, and the arrow D indicates the “downward direction”.

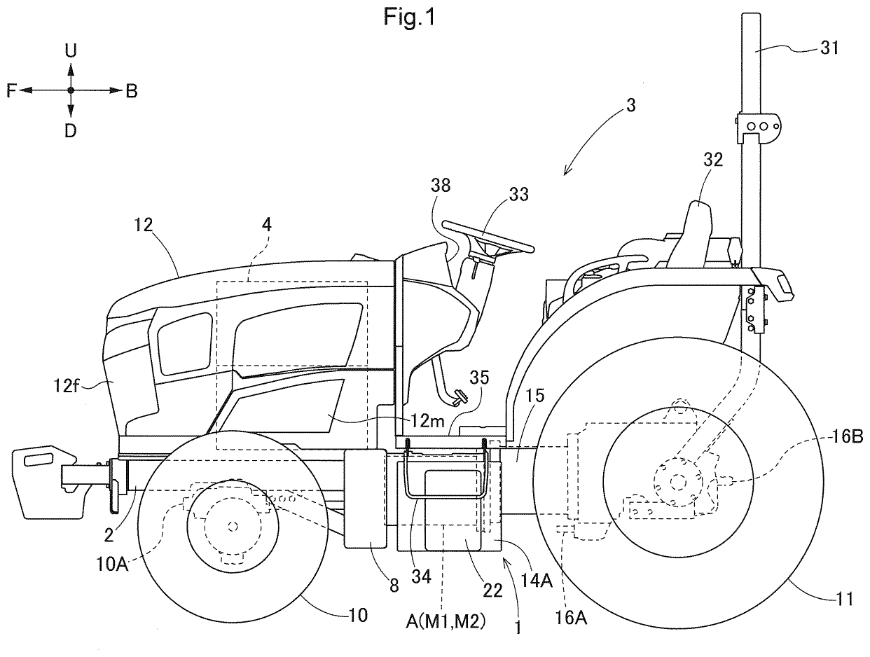

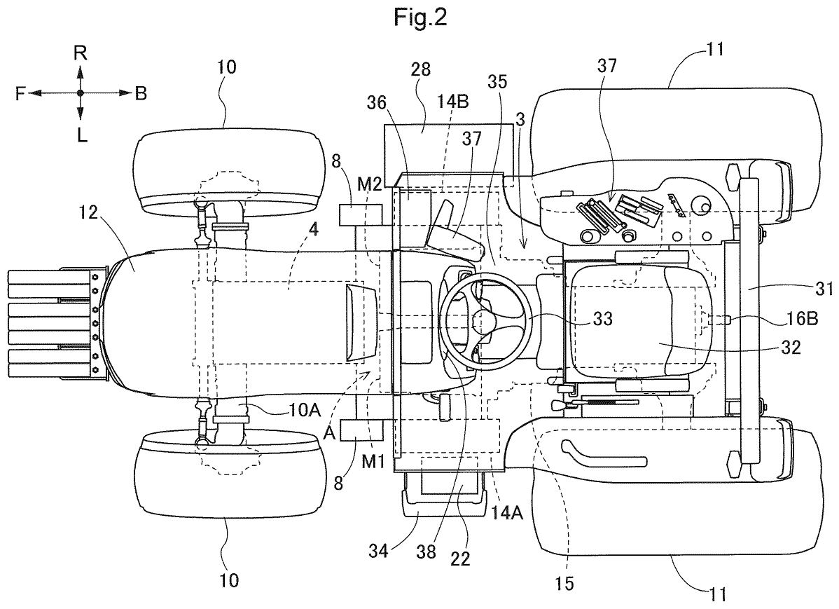

As shown in FIGS. 1 and 2, left and right front wheels 10 (corresponding to “travel devices”) are provided at a front portion of a tractor body 1, and left and right rear wheels 11 (corresponding to “travel devices”) serving as rear travel devices are provided at a rear portion of the tractor body 1. The tractor body 1 supports the front wheels 10 and the rear wheels 11.

The tractor body 1 includes a front frame 2, an accommodation frame A, and a transmission case 15. The front frame 2 is coupled to a front portion of the accommodation frame A, and the transmission case 15 is coupled to a rear portion of the accommodation frame A, thus providing a frame structure of the tractor body 1. An electric motor M1 and an electric motor M2 as motive power sources are accommodated in the accommodation frame A.

A front axle case 10A is attached to the front frame 2, and the left and right front wheels 10 are supported by the front axle case 10A. The front frame 2 supports the front axle case 10A. The transmission case 15 includes an axle case that transmits motive power to the left and right rear wheels 11, and the transmission case 15 supports the left and right rear wheels 11.

A driving section 3 on which an operator rides is provided above the accommodation frame A and the transmission case 15. A ROPS frame 31 attached to the transmission case 15 and extending upward is provided at a rear portion of the driving section 3. A first battery 4 (corresponding to a “battery”) for driving that supplies power to the electric motors M1 and M2 is attached to the front frame 2, and a hood 12 that covers the first battery 4 is provided.

The first battery 4 is placed and supported on the front frame 2. The front frame 2 is used both to support the first battery 4 and to support the front axle case 10A of the front wheels 10. The first battery 4 stores power for traveling, working, and hydraulic driving.

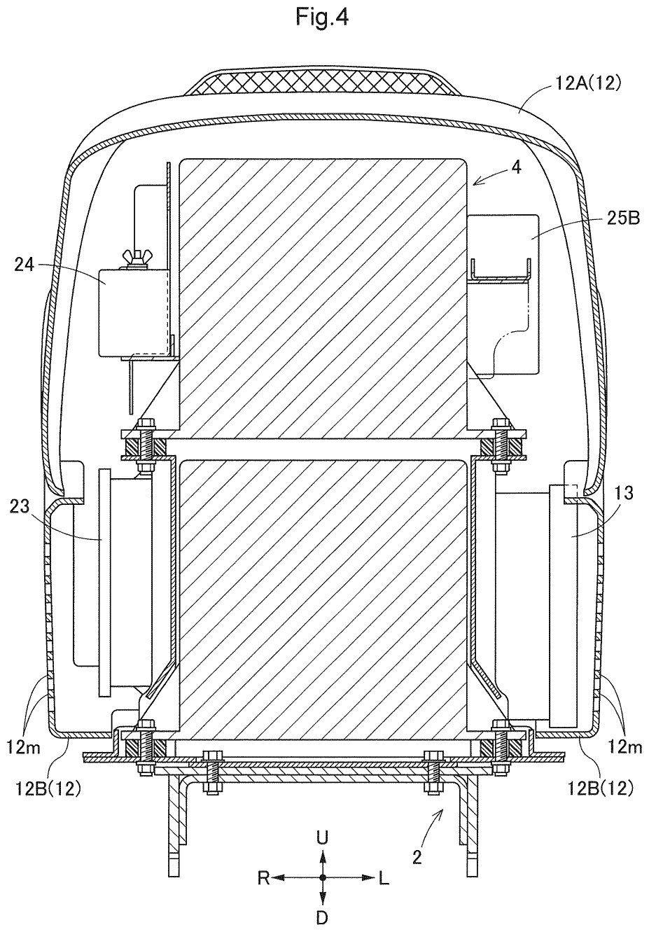

As shown in FIG. 4, the hood 12 includes a swing section 12A that swings in such a manner as to be opened and closed, and a fixed portion 12B fixed below the swing section 12A. The hood 12 is configured to be opened and closed by the swing section 12A swinging about a transverse axis extending in the left-right direction of the tractor body. The first battery 4 is covered by the hood 12 while the swing section 12A is closed.

As shown in FIG. 2, the electric tractor includes an electric motor M1 for traveling and an electric motor M2 for working and hydraulic driving. The electric motor M1 receives a supply of power from the first battery 4, and drives the front wheels 10 and the rear wheels 11. The electric motor M2 receives a supply of power from the first battery 4, and drives a work apparatus as will be described below.

The electric tractor includes two inverters 14A and 14B respectively corresponding to the two electric motors M1 and M2. The electric motors M1 and M2 are disposed on the rear side of the tractor body relative to the first battery 4. The inverters 14A and 14B are provided laterally outward of the electric motors M1 and M2.

The first battery 4 supplies power to the two inverters 14A and 14B. Each of the inverters 14A and 14B receives direct current from the first battery 4, and converts the direct current into three-phase alternating current. The direct-current power from the first battery 4 is converted into alternating-current power in the left inverter 14A, and the alternating-current power is supplied to the electric motor M1. Accordingly, the electric motor M1 operates. The direct-current power from the first battery 4 is converted into alternating-current power in the right inverter 14B, and the alternating-current power is supplied to the electric motor M2, whereby the electric motor M2 operates.

Left and right loader attachment sections 8 are respectively coupled to left and right side portions of the accommodation frame A. A work apparatus (not shown) such as a front loader is detachably attached to each of the left and right loader attachment sections 8.

As shown in FIGS. 1 and 2, the driving section 3 is provided rearward of the first battery 4 and the hood 12. The driving section 3 includes the ROPS frame 31, a driver's seat 32, a steering handle 33 for steering the front wheels 10, a step 34, a floor 35, a charging socket 36, a work travel operation member 37, a display 38, and so forth.

The driving section 3 is supported by the accommodation frame A and the transmission case 15. The electric motors M1 and M2 are disposed below the floor 35 of the driving section 3 and inside the accommodation frame A in such a manner as to be arranged side by side in the left-right direction.

Although not described in detail, the work travel operation member 37 includes an acceleration operating member to regulate the traveling speed, and an operation member to regulate the rotation speed of a mid PTO shaft 16A and a rear PTO shaft 16B, which will be described below. This enables the operator to perform various driving operations in the driving section 3. The display 38 displays, for example, the traveling state and the work state of the vehicle body, information regarding the first battery 4 (charge amount and temperature), and so forth.

The charging socket 36 is provided rightward of the steering handle 33 and directly above the floor 35. The first battery 4 is charged in response to the operator inserting an adapter of a charger into the charging socket 36. The charging socket 36 accepts received power to charge the first battery 4. The charging socket 36 supports normal charging for accepting alternating-current power (AC power supply) from an external power source, and fast charging for accepting high-voltage direct-current power for fast charging. The standard of the fast charging may be, for example, CHAdeMO, CCS2, GB/T, ChaoJi, NACS, or the like.

The accommodation frame A, the electric motors M1 and M2, the inverters 14A and 14B, and the transmission case 15 are disposed below the floor 35. The first battery 4 is disposed above the floor 35. In addition, the first battery 4 is provided on the front side of the driving section 3 such that a rear end portion of the first battery 4 is located on the front side of front end portions of the electric motors M1 and M2.

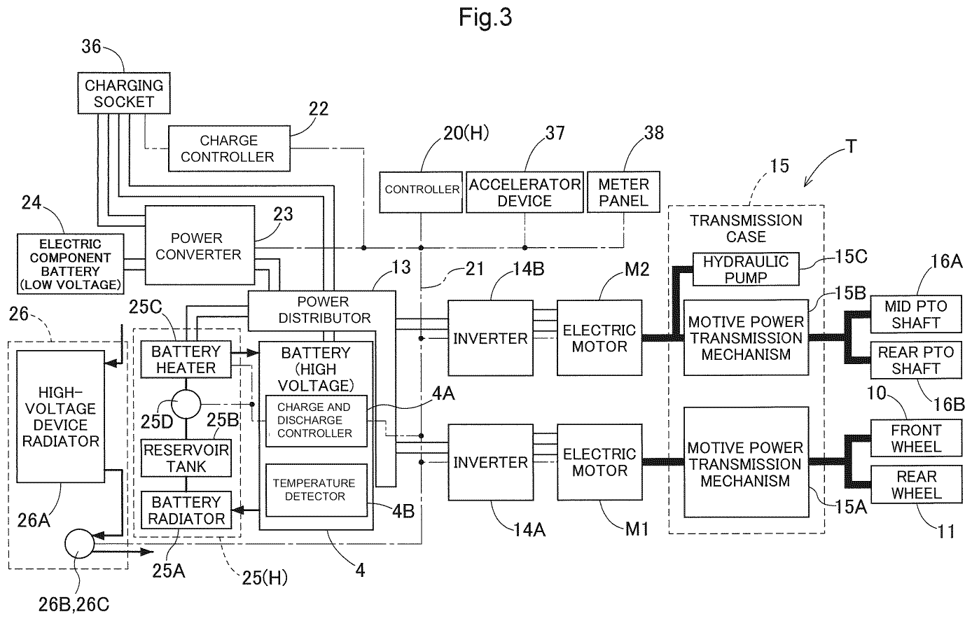

As shown in FIG. 3, the motive power transmission device T includes a traveling motive power transmission mechanism 15A, a working motive power transmission mechanism 15B, and a hydraulic pump 15C. The transmission case 15 accommodates the traveling motive power transmission mechanism 15A, the working motive power transmission mechanism 15B, and the hydraulic pump 15C. That is, the motive power transmission device T includes the transmission case 15, the traveling motive power transmission mechanism 15A, the working motive power transmission mechanism 15B, and the hydraulic pump 15C.

A mid PTO shaft 16A and a rear PTO shaft 16B are provided. The working motive power transmission mechanism 15B receives rotational motive power from the electric motor M2, and distributes the rotational motive power to the mid PTO shaft 16A and the rear PTO shaft 16B.

The working motive power transmission mechanism 15B transmits working motive power from the electric motor M2 to the mid PTO shaft 16A and the rear PTO shaft 16B. Then, the mid PTO shaft 16A and the rear PTO shaft 16B supply the working motive power to the work apparatus.

The hydraulic pump 15C receives rotational motive power from the electric motor M2 and is driven to rotate. For example, in a case where a front loader is mounted as the work apparatus, hydraulic fluid is supplied by the hydraulic pump 15C, and the work apparatus (front loader) is driven by the electric motor M2.

The work apparatus connected to the mid PTO shaft 16A may be, for example, a mowing apparatus, a rotary rake, a leaf cutting apparatus, a sprayer apparatus, or the like. The mid PTO shaft 16A may be used as a front PTO shaft for a work apparatus mounted to a front portion of the tractor body 1. The work apparatus connected to the rear PTO shaft 16B may be a rotary cultivator apparatus, an intertillage management apparatus, a ridging apparatus, or the like.

As shown in FIG. 3, the electric tractor includes a controller 20 configured to control the driving of the electric motors M1 and M2 in response to an operation performed on the work travel operation member 37. The controller 20 is a core element of a control system of the electric tractor, includes a microcomputer, and is configured or programmed to execute various types of operation processing. The controller 20 is configured or programmed to include a temperature regulation controller configured or programmed to control the operation of a battery temperature regulator, which will be described below.

The controller 20 is connected to a charge and discharge controller 4A of the first battery 4, the inverters 14A and 14B, the electric motors M1 and M2, a charge controller 22, a power converter 23, the work travel operation member 37, the display 38, and so forth in such a manner as to communicate data therewith via a signal harness 21 using a controller area network (CAN), for example. The power converter 23 includes an on-board charger (OBC) and a DC/DC converter, and converts the power supplied from the external power source to on-board power.

The controller 20 is configured or programmed to output a command signal to each of the inverters 14A and 14B in response to a command from the work travel operation member 37. In response to the command signal from the controller 20, the inverter 14A adjusts the three-phase alternating power (voltage value, frequency, current value, etc.) supplied to the electric motor M1 from the first battery 4, thus controlling the output of the electric motor M1. In response to the command signal from the controller 20, the inverter 14B adjusts the three-phase alternating power supplied to the electric motor M2 from the first battery 4, thus controlling the output of the electric motor M2.

The controller 20 is configured or programmed to control the operation of the display 38. Operational states of the electric motors M1 and M2, information regarding the first battery 4, and so forth are displayed on the display 38.

The first battery 4 is a lithium ion battery. Although not shown, the first battery 4 may include a stack of a large number of small, low-voltage cells. The output voltage of the first battery 4 is 400 volts, for example. The plurality of cells are stored in an accommodation case in a sealed state.

The first battery 4 is electrically conductively connected to a power distributor 13. The power distributor 13 is also electrically conductively connected to the charging socket 36, the inverters 14A and 14B, and the power converter 23. Accordingly, the power distributor 13 functions as a hub that distributes power from the first battery 4 to the inverters 14A and 14B and the power converter 23. The power distributor 13 also has a function of transmitting power from the charging socket 36 to the first battery 4.

The first battery 4 includes the charge and discharge controller 4A. The charge and discharge controller 4A is configured to control the discharge current, the charge current, and the like of the first battery 4 based on the output voltage, the received voltage, and the exothermic temperature or the like of the first battery 4.

The first battery 4 includes a temperature detector 4B as temperature detector that detects the temperature of the first battery 4. Although not described in detail, the temperature detector 4B is configured to detect a temperature for each of the plurality of cells.

The power converter 23 is electrically conductively connected to the charging socket 36 and the power distributor 13. The charge controller 22 regulates the power supplied from the charging socket 36. The charge controller 22 may be, for example, a power module including a microcomputer or a programmable logic controller (PLC) that executes a program based on a control signal from the controller 20, or may be a relay circuit that operates based on an electric signal from the controller 20. The charge controller 22 is configured or programmed to control the charge voltage and the charge current applied to the first battery 4 when charging (including quick charging) the first battery 4. The charge controller 22 is configured or programmed to regulate the power received from the charging socket 36, and supply the regulated power to the first battery 4 as charging power.

The electric tractor includes, in addition to the first battery 4, a second battery 24 that supplies power to the controller 20 and other electric components. The second battery 24 is a lead-acid battery. The second battery 24 has an output voltage that is lower than the output voltage of the first battery 4, and supplies power of a low voltage (e.g., 12 volts) to drive the electric components.

The second battery 24 is charged by the power supplied from the first battery 4 via the DC/DC converter included in the power converter 23. The power converter 23 is electrically conductively connected to the first battery 4 and the second battery 24, and is capable of receiving power from the first battery 4, lowering the voltage of the power, and transmitting the power to the second battery 24. Therefore, the second battery 24 is capable of being charged by power received from the first battery 4 via the power converter 23.

Heavy current devices that receive power from the first battery 4 at a high voltage tend to increase in temperature due to heat generation. For this reason, the electric work vehicle includes a high-voltage device cooling device 26 for cooling heavy current devices. The high-voltage device cooling device 26 includes a high-voltage device radiator 26A and pumps 26B and 26C. The pumps 26B and 26C are connected in series.

The pumps 26B and 26C pump a refrigerant for cooling heavy current devices that operate based on electric power, such as the inverters 14A and 14B, the electric motors M1 and M2, and the power converter 23. When the pumps 26B and 26C are operated, the refrigerant flows through cooling flow paths in the heavy current devices such as the inverters 14A and 14B, the electric motors M1 and M2, and the power converter 23, thus cooling the heavy current devices. Then, the refrigerant heated by the heavy current devices is cooled in the high-voltage device radiator 26A through heat dissipation. The order of the cooling flow paths of the heavy current devices may be changed as appropriate.

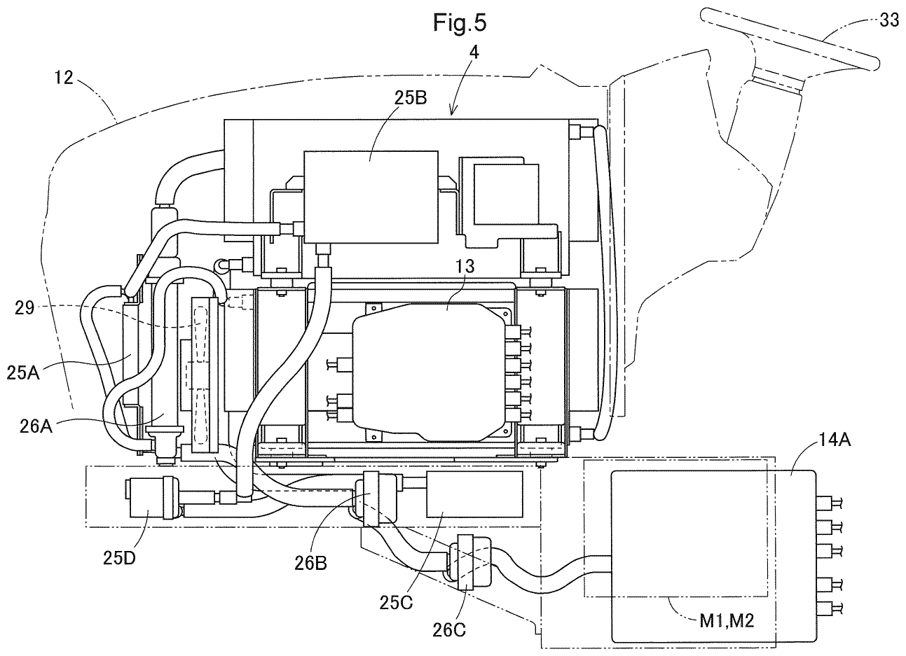

As shown in FIG. 5, the high-voltage device radiator 26A and a battery radiator 25A are disposed forward of the first battery 4 in such a manner as to be arranged one in front of the other. A cooling fan 29 is provided rearward of the high-voltage device radiator 26A and the battery radiator 25A, and forward of the first battery 4. The cooling fan 29 creates cooling air for cooling the refrigerant inside the high-voltage device radiator 26A and the battery radiator 25A. A front grille 12f (see FIG. 1) is provided at the front of the hood 12, and outside air from the front of the battery radiator 25A is introduced as the cooling air. The cooling fan 29 is configured to create cooling air that flows rearward. The cooling air promotes heat dissipation of the battery radiator 25A and the high-voltage device radiator 26A.

The electric tractor according to the present example embodiment includes a temperature regulator H that regulates the temperature of the first battery 4 using power, and the temperature regulator H operates such that the temperature of the first battery 4 increases if the temperature of the first battery 4 detected by the temperature detector 4B is lower than a first set temperature.

If the temperature of the first battery 4 is lower than the first set temperature, the temperature regulator H converts the power supplied from the external power source into power suppliable to a heater (battery heater 25C) as on-board power, and supplies the converted power to the heater (battery heater 25C). If the temperature of the first battery 4 is higher than the first set temperature, the temperature regulator H switches the state of power supply so as to convert the power supplied from the external power source into power suppliable to the first battery 4 as on-board power, and supply the converted power to the first battery 4.

The temperature regulator H includes a temperature regulator 25 to manage the temperature of the first battery 4, and the controller 20 (specifically, a temperature regulation controller that controls the operation of the temperature regulator).

The temperature regulator 25 will now be described. As shown in FIG. 5, the temperature regulator 25 is provided in the vicinity of the first battery 4. As shown in FIG. 3, the temperature regulator 25 includes the battery radiator 25A, a reservoir tank 25B, the battery heater 25C, a pump 25D, and a circulation flow path through which the refrigerant circulates through the interior of the first battery 4 and the above-described devices. The refrigerant is an insulating oil or the like, for example.

The battery radiator 25A is provided between the reservoir tank 25B and an outlet of a temperature control flow path that is included in the circulation flow path and is located inside the first battery 4. Accordingly, the refrigerant that has been heated in the temperature control flow path located inside the first battery 4 is cooled in the battery radiator 25A through heat dissipation, and returned to the reservoir tank 25B.

The refrigerant is stored in the reservoir tank 25B. The pump 25D pumps the refrigerant such that the refrigerant circulates in the first battery 4. The battery heater 25C increases the temperature of the first battery 4 by heating the refrigerant. When the pump 25D is operated, the refrigerant circulates from the reservoir tank 25B through the battery heater 25C, the pump 25D, the temperature control flow path located inside the first battery 4, and the battery radiator 25A in this order.

If the temperature of the first battery 4 detected by the temperature detector 4B is lower than the first set temperature, the controller 20 is configured or programmed to operate the temperature regulator 25 using the power supplied from the external power source such that the temperature of the first battery 4 increases. The first set temperature is set to a temperature corresponding to the lower limit value of an allowable temperature range of the first battery 4, for example, −19° C.

If the temperature of the first battery 4 detected by the temperature detector 4B is higher than the first set temperature and lower than a second set temperature (for example, 0° C.) that is higher than the first set temperature, the controller 20 operates the temperature regulator 25 using the power supplied from the first battery 4 such that the temperature of the first battery 4 increases.

After operating the temperature regulator 25 using the power supplied from the external power source while the temperature of the first battery 4 is lower than the first set temperature, the controller 20 stops the temperature increasing operation of the temperature regulator 25 in response to the temperature of the first battery 4 increasing to the second set temperature or more.

Specifically, the controller 20 switches the state of power supply in such a manner as to, if the temperature of the first battery 4 is lower than the first set temperature, convert the power (alternating-current power) from the external power source into power suppliable to the battery heater 25C of the temperature regulator 25, and supply the converted power to battery heater 25C, and, if the temperature of the first battery 4 is higher than the first set temperature, convert the power (alternating-current power) from the external power source into power suppliable to the first battery 4, and supply the converted power to the first battery 4.

The first battery 4 is not charged and discharged if the temperature of the first battery 4 detected by the temperature detector 4B is lower than the first set temperature.

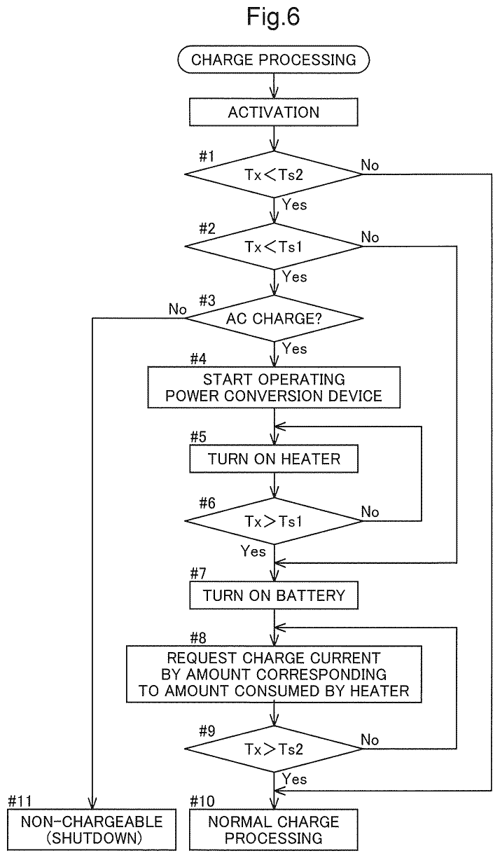

Charge processing performed by the controller 20 will be described in detail below with reference to the flowchart of FIG. 6.

Upon activation of the charge operation, the controller 20 determines whether the temperature of the first battery 4 detected by the temperature detector 4B is lower than a second set temperature Ts2 (0° C.) (step #1), and also determines whether the temperature of the first battery 4 detected by the temperature detector 4B is lower than a first set temperature Ts1 (−19° C.) (step #2). At this time, the controller 20 determines whether the lowest temperature among the temperatures of the plurality of cells is lower than the first set temperature Ts1 as the temperature of the first battery 4.

If the temperature of the first battery 4 is lower than the first set temperature Ts1 (−19° C.), and power (alternating-current power) (AC) from the external power source is available (step #3), the controller 20 operates the power converter 23 (OBC) to convert the alternating-current power into direct-current power suitable for the battery heater 25C, and supply that power to the battery heater 25C to operate the battery heater 25C (steps #4 and #5). That is, the state of electric conduction by the power distributor 13 is switched to switch the state of power supply. At this time, the power distributor 13 and the first battery 4 are disconnected from each other, and the first battery 4 is neither charged nor discharged.

Since it is envisioned that a heating medium has a high viscosity when the temperature of the first battery 4 is lower than the first set temperature Ts1 (−19° C.), the pump 25D may be operated while the refrigerant is increased in temperature and reduced in viscosity after operating the battery heater 25C.

In response to the temperature of the first battery 4 becoming higher than the first set temperature Ts1 (−19° C.), the first battery 4 is switched to an operative state (steps #6 and #7). That is, the state of electric conduction by the power distributor 13 is switched to establish connection to the first battery 4, whereby the first battery 4 becomes chargeable and dischargeable. Then, the power converter 23 (OBC) operates to switch the state of power supply to a state of converting the alternating-current power into direct-current power suitable for the first battery 4 and supplying the converted power to the first battery 4.

Thereafter, the controller 20 requests, from the first battery 4, an amount of charge current corresponding to the amount of power consumed by the battery heater 25C, and operates the battery heater 25C using the power from the first battery 4 (step #8). At this time, the pump 25D is also operated. This increases the temperature of the first battery 4.

In response to the temperature of the first battery 4 becoming higher than the second set temperature Ts2 (0° C.), the operation of the battery heater 25C is stopped, thus transitioning to normal charge processing (steps #9 and #10). After transitioning to the normal charge processing, in response to the state of charge (SOC) decreasing while the charging condition of the first battery 4 is being checked, the first battery 4 is charged from the external power source, with the external power source connected to the charging socket 36. Upon completion of charging, the charge operation ends.

In step #3, in a case where the external power source (alternating-current power) is not connected to the charging socket 36, no operation can be performed, and therefore charging cannot be performed, whereby the power distributor 13 and the first battery 4 are disconnected from each other, and the first battery 4 can be neither charged nor discharged (step #11).

The present invention is not limited to the configurations illustrated in the above-described example embodiments, and representative alternative example embodiments of the present invention will be illustrated below.
(1) In a case where the temperature of the first battery 4 is lower than the first set temperature Ts1 (−19° C.), the temperature regulator H may operate using power from the second battery 24, in place of power supplied from the external power source.
(2) In response to the temperature of the first battery 4 becoming higher than the first set temperature Ts1, the temperature regulator H may operate using power supplied from the external power source, in place of power supplied from the first battery 4.
(3) In a case where the temperature of the first battery 4 is lower than the first set temperature Ts1, and the temperature regulator H has performed a temperature increasing operation, the temperature increasing operation may be continued even after the temperature of the first battery 4 has increased to the second set temperature Ts2 or more.
(4) As the temperature regulator H, a configuration including an electric heater that heats the first battery 4 from the outer peripheral side of the accommodation case may be included in place of the configuration including the circulation flow path through which the refrigerant circulates, and the heater that heats the refrigerant.
(5) The temperature regulator H may be configured to operate if the average value of the temperatures of the plurality of cells is lower than the first set temperature.
(6) The first battery 4 may be a battery different in type from a lithium ion battery, and the second battery 24 may be a battery different in type from a lead-acid battery.
(7) For the first set temperature Ts1, the temperature “−19°C” is merely an example. The present disclosure is not limited thereto, and a different temperature may be set. Also, for the second set temperature Ts2, the temperature “0° C” is merely an example. The present disclosure is not limited thereto, and a different temperature may be set.
(8) In the above example embodiments, the electric tractor is illustrated as an example of the electric work vehicle. However, the electric work vehicle is not limited to an electric tractor, and the present disclosure is applicable to work vehicles that perform various operations, such as a harvester, a rice planter, and construction equipment.
(9) The above example embodiments show a case where the present disclosure is applied to an electric vehicle that drives the travel device by the electric motor M1. However, the present disclosure may be applied to a hybrid vehicle including a travel device that uses both driving force generated by power from a battery and driving force generated by motive power from an engine.

Note that the configurations disclosed in the example embodiments described above (including the alternative example embodiments, the same applies to the following) are applicable in combination with configurations disclosed in other example embodiments so long as no inconsistency arises. The example embodiments disclosed herein are illustrative, and example embodiments of the present invention are not limited thereto. Appropriate changes and modifications may be made without departing from the scope and spirit of the present invention.

Various types of operation processing in the example embodiments described above are implemented by processing circuitry including one or more processors. The processing circuitry may be configured by an integrated circuit or the like in which, in addition to the one or more processors, one or more memories, various analog circuits, and various digital circuits are combined. The one or more memories store a program (instructions) for causing the one or more processors to execute the various types of processing. The one or more processors may execute the various types of processing in accordance with the program read out from the one or more memories, or may execute the various types of processing in accordance with a logic circuit designed in advance to execute the various types of processing. The processors may be various processors adapted to control a computer, including, for example, a central processing unit (CPU), a graphics processing unit (GPU), a digital signal processor (DSP), a field programmable gate array (FPGA), and an application specific integrated circuit (ASIC). Note that the above-described plurality of processors that are physically separated may cooperate each other to execute the various types of processing. For example, the processors respectively mounted in a plurality of physically separated computers may cooperate each other to execute the various types of processing via a network such as a local area network (LAN), a wide area network (WAN), and the Internet. The program may be installed in the memory from an external server device or the like via the network, or may be distributed in a state of being stored in a recording medium such as a compact disc read only memory (CD-ROM), a digital versatile disk read only memory (DVD-ROM), or a semiconductor essential memory to be installed in the memory from the recording medium.

Example embodiments of the present invention are applicable to electric work vehicles each including a battery and an electric motor to transmit motive power to a travel device using power from the battery.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electric work vehicle comprising:
a battery;
an electric motor configured to transmit motive power to a travel device using power from the battery;
a temperature regulator configured to regulate a temperature of the battery using power; and
a temperature detector configured to detect a temperature of the battery; wherein
in response to the temperature detected by the temperature detector being lower than a first set temperature, the temperature regulator is configured to operate such that the temperature of the battery increases.

2. The electric work vehicle according to claim 1, wherein the temperature regulator is configured to operate using power supplied from an external power source.

3. The electric work vehicle according to claim 1, wherein, in response to the temperature of the battery detected by the temperature detector being higher than the first set temperature and lower than a second set temperature that is higher than the first set temperature, the temperature regulator is configured to operate using power supplied from the battery such that the temperature of the battery increases.

4. The electric work vehicle according to claim 3, wherein in response to the temperature of the battery increasing to the second set temperature or more, the temperature regulator is configured to stop a battery temperature increasing operation.

5. The electric work vehicle according to claim 1, wherein the temperature regulator includes a circulation flow path through which a refrigerant circulates through an interior of the battery, and a heater configured to heat the refrigerant and perform a heating operation using received power.

6. The electric work vehicle according to claim 5, further comprising:
a power converter configured to convert power supplied from an external power source into on-board power; wherein the temperature regulator is configured to switch a state of power supply to, in response to the temperature of the battery being lower than the first set temperature, convert the power supplied from the external power source into power suppliable to the heater as the on-board power and supply the converted power to the heater, and to, in response to the temperature of the battery being higher than the first set temperature, convert the power supplied from the external power source into power suppliable to the battery as the on-board power and supply the converted power to the battery.

7. The electric work vehicle according to claim 1, wherein the battery is not charged while the temperature of the battery is lower than the first set temperature.

8. The electric work vehicle according to claim 1, wherein
the battery includes a plurality of cells;
the temperature detector is configured to detect a temperature for each of the plurality of cells; and
the temperature regulator is configured to operate in response to a lowest temperature among the temperatures of the plurality of cells being lower than the first set temperature.

9. The electric work vehicle according to claim 1, wherein motive power is transmittable to a work apparatus using power from the battery.

10. The electric work vehicle according to claim 1, further comprising:
a second battery different from the battery and configured to supply power to an electric component; wherein
the second battery is configured to supply power to the electric component at a temperature lower than the first set temperature.

11. The electric work vehicle according to claim 10, wherein the battery is a lithium ion battery, and the second battery is a lead-acid battery.
